(19) United States
(12) Patent Application Publication
(10) Pub. No.: US 2009/0205412 A1
(43) Pub. Date: Aug. 20, 2009

(54) Method For Obtaining And Analyzing Solids, Preferably Crystals

(75) Inventors: Danny Dirk Pieter Willem Stam, Den Haag (NL); Adrianus Hendricus Joseph Franciscus de Keijzer, Hoogerheide (NL); Emilio Rene Bodenstaff, Delft (NL); Mimoun Lamkadmi, Rotterdam (NL)

Correspondence Address: HOFFMANN & BARON, LLP, 6900 JERICHO TURNPIKE, SYOSSET, NY, 11791, US

(73) Assignee: AVANTIUM INTERNATIONAL B.V., Amsterdam (NL)

(21) Appl. No.: 12/304,800

(22) PCT Filed: Jul. 17, 2006
(86) PCT No.: PCT/NL06/00371

§ 371 Date: Apr. 3, 2009

(51) Int. Cl. G01N 1/28; B01L 3/06

(52) U.S. Cl. 73/64.56; 422/101

(57) ABSTRACT

The present invention pertains to a method for obtaining and analyzing solids, preferably crystals, which method comprises the following steps: providing a well plate, the well plate comprising a plurality of wells, each of the wells having a depth and an open upper end and each of the wells being provided with a filter having pores, which filter is arranged at a distance below the open upper end, each of the wells having an upper inner wall part above the filter that has a fluid contact surface and each filter having a top filter surface, at least both the fluid contact surface of the well and the top filter surface being of a material that is at least substantially inert for organic and/or aqueous solvents and/or mixtures of organic and aqueous solvents, providing one or more substances and one or more solvents in at least one of the wells of the well plate, applying conditions to dissolve the one or more substances in the one or more solvents; applying conditions for crystallizing at least a part of the substance so that solids are formed in the at least one well, substantially removing the part of the substance that remains in solution, thereby leaving the solids, preferably crystals, that were formed from the substance in the well of the well plate in which they were formed, performing further investigation of the solids, preferably crystals in the well of the well plate where they were formed.

### CROSS-REFERENCE TO RELATED APPLICATIONS

This application is the National Stage of International Application No. PCT/NL2006/000371, filed Jul. 17, 2006, the contents of which is incorporated by reference herein.

### FIELD OF INVENTION

The invention relates to a method for obtaining and analyzing solids, preferably crystals. The method according to the invention is particularly suitable for use in research requiring the handling of solids or mixtures of solids and liquids, such as in research with respect to crystals.

### BACKGROUND OF INVENTION

From the prior art, methods are known in which well plates are used for crystallization. Such a well plate is provided with a plurality of recesses, for example 64 or 96 recesses per plate. In each recess a substance is provided, which substance typically is a mixture of components to be crystallized out of one or more solvents. After providing the recesses with the substance, the well plate is put in an incubator, in which the crystallization takes place. After crystallization, the well plates are removed from the incubator. The crystals are removed from the well plate and put into a different well plate for further investigation, for example by means of X-ray diffraction.

A disadvantage of this known method is that the crystals have to be removed from one well plate and transferred into another. Crystals are usually very vulnerable, so the handling of these crystals is difficult as damage to the crystals is to be avoided. Moreover, the handling of the crystals is labour intensive. Sometimes, it is hard to harvest the crystals from the first well plate because only a very small amount of crystals has been formed.

U.S. Pat. No. 6,507,636 discloses a well plate in which it is not always necessary to transfer the crystals from the well plate in which crystallization took place to a well plate that is suitable for further investigation. This known well plate comprises a flat base plate over which a masking plate with through bores is placed. The base plate and the masking plate are connectable to each other in a liquid tight manner. The masking plate is made of metal, while the base plate is made of an optically transparent material, such as silicon, quartz or sapphire (when reflection X-ray diffraction is used in the further investigation) or of thin polymer film of polyacetate (when transmission X-ray diffraction is used in the further investigation).

In the known well plate, the conditions for crystallisation are applied while the base plate and the masking plate are connected to each other in a liquid tight manner. Thereafter, the masking plate is removed, leaving a plurality of little heaps of solids, preferably crystals on the flat base plate. The solids are then subjected to further investigation, such as X-ray diffraction.

A disadvantage of the known plate is that the known plate does not allow filtration of the mixture of liquids and solids that results after a period of crystallization. Any remaining mother liquor that remains after the crystallization process has to be separated from the solids, and/or any remaining solvents that remain after the crystallization process have to be evaporated. Moreover, the base plate has to be handled with the ultimate care in order to avoid mixing of solids of adjacent heaps or any other form of cross contamination between the individual samples.

### SUMMARY OF THE INVENTION

The object of the invention is to provide an improved method for obtaining and analyzing solids, preferably crystals.

This object is achieved by a method according to the present invention.

The well plate that is used in the method according to the present invention is suitable for use in both crystallization and in a wide array of further treatments that are commonly performed on crystals in research environments.

Because the formed solids remain in the wells in which they are formed, it is easy to prevent that the solids formed in different wells are mixed up or that the samples formed in one well are contaminated with solids that were formed in other wells.

In the method according to the invention, it is not necessary that the further investigation takes place directly after the crystallization. It is envisaged that after the forming of the solids, the well plate is sealed from the environment if such sealing is necessary, and then stored.

In the crystallization process or in the further treatment of the solids, often aggressive chemicals are used. Therefore, the fluid contact surface of the well surface and of the top filter surface is at least substantially inert for organic and aqueous solvents or mixtures thereof at the temperatures that occur in the crystallization process and the subsequent investigation. The fluid contact surface is that part of the inner wall of a well that in use is or is likely to come into contact with the substance that is arranged in the well.

For example perfluorinated polymers are suitable for the fluid contact surface and the top filter surface. Examples of suitable materials for the fluid contact surfaces and/or the top filter surfaces are polyvinylidene fluoride, polytetrafluoroethylene, perfluoroalkoxy, fluorinated ethylene propylene, polytetrafluoroethylene-perfluoromethylvinylether, tetrafluoroethylene hexafluoropropylene vinylidene fluoride, ethylene tetrafluoroethylene, ethylene chloro-trifluoroethylene, polyetheretherketone, polyetherimide.

Moreover, the well plate as used in the method according to the present invention can be manufactured at a low cost, so the well plate can be discarded after use. Therefore, some damage due to aggressive chemical substances can be acceptable.

The crystallization process often requires that the well plate and its contents are subjected to a temperature profile that comprises elevated temperatures. Therefore, adequate heat transfer to the substance in the well is required. Polymers in general are not such good heat conductors. The well plate according to the invention however, preferably has wells that protrude from the lower face of intermediate plate sections that are present between adjacent wells in the well plate. The part of the outer wall of the wells that protrudes from the lower face of the intermediate plate sections can be used to supply heat to, so the heat has only a short way to follow to reach the inside of the well.

Techniques such as X-ray diffraction and spectroscopy are widely used in investigation of solids, for instance to differentiate between amorphous solids and crystalline polymorphs. Therefore, the well plate to be used in the method according to the invention is in a preferred embodiment made of a material that is preferably X-ray transparent, such as Ultem (polyetherimide, General Electric Corp.) Instead of being made of a material that is X-ray transparent, the well plate can also be made of a material that is somewhat X-ray absorbent, but always gives a defined, recognizable absorption pattern that can be filtered out of the measurement signal. Examples of such materials are PVDF or PFA.

Instead of being made of any X-ray transparent material or of a material that is somewhat X-ray absorbent, but always gives a defined, recognizable absorption pattern, it is also possible that at least the fluid contact surfaces and the top filter surfaces of the wells are coated with any such material. It is also envisaged that a well plate is used in which the top filter surfaces are both chemically resistant to the organic and/or aqueous solvents (or the mixture thereof) that is used in the crystallization process and X-ray transparent, while the walls of the wells are chemically resistant but not X-ray transparent.

So, the well plate to be used in the method according to the invention is resistant to aggressive chemicals, conductive for heat and preferably X-ray transparent. This can for example be achieved by making the well plate from one or more perfluorinated polymers or by coating at least the fluid contact surfaces and the top filter surfaces of the wells with such a polymer or polymers.

The well plate suitable for use in the method according to the invention can be made from a single type of inert material, but it is also possible to use material with a coating of a inert material or to make the well plate from a combination of two or more inert materials such as perfluorinated polymers or PEEK. In the latter case, eg. the filters can be made of a different perfluorinated polymer than the rest of the well plate.

The method according to the invention is usable for crystallization of all kinds of substances and for further investigations into the crystals that are formed. More in particular, the method according to the invention is suitable for the crystallization and investigation that is performed in the context of combinatorial research, and in particular crystallization and investigation in the context of research into active pharmaceutical ingredients. The method according to the invention is suitable for use in polymorphic screening, salt screening and/or co-crystal screening.

Preferably, the wall thickness of a well is smaller than the depth of that well. This way, the length of the path that the heat has to cover from its source to the inside of the well is even further shortened. In a preferred embodiment, a filter is arranged at a level below the lower face of the adjacent intermediate plate sections. More preferably, the filter is arranged at the lower end of the respective well.

It is envisaged that the well plate to be used in the method according to the invention is made by means of injection moulding. This is a cheap and reliable way of manufacturing the well plates according to the invention. With the well plates being cheap, they can be discarded after a single use, so that a disposable well plate is obtained.

It is however also possible to manufacture well plates according to the invention by means of any material removing operation. Another possibility is that first a plate is formed that is provided with wells that still have an open bottom. Such a plate can for example be made by injection moulding or material removing operations. After making the plate, filters can be applied to the open bottom ends or at a distance above these open bottom ends of the wells. For example, the filters can be connected to the walls of the respective wells by means of ultrasonic welding.

In a simple embodiment the well plate is entirely made of the same material, for example a perfluorinated polymer. It is however also possible to make the well plate of one or more materials that are provided at least partially with coating, which coating is for example made of a perfluorinated polymer. Such a coated well plate can also be manufactured by means of injection moulding. This way, a monolithic well plate can be obtained despite the fact that the well plate comprises at least two materials. It is of course also possible to coat one perfluorinated polymer with an other perfluorinated polymer.

Preferably, the diameter of the pores in the filter is between 0.05 micrometer and 10 micrometer. More preferably, the diameter of the pores in the filter is between 0.1 micrometer and 5 micrometer. A successful embodiment is known that has an average pore diameter of about 1.2 micrometer. However, in case of large crystals, the pores can be far larger, for example even about 1 mm.

It is envisaged that the wells of the well plates are arranged along a line or in the form of a matrix. Multiple well plates can be combined to form a larger matrix.

In a preferred embodiment, the well plate is combined with a well plate support, which is for example made of metal. The well plate support provides additional mechanical stability to the well plate.

It is envisaged that heat is supplied to the wells through the well plate support. In that case it is advantageous if the well plate support is in contact with the outer wall of one or more wells.

The open upper end of the wells are preferably sealable. The seal can for example be a septum or a stopper. The seal can be made from the same or a different inert material as the wells. If PTFE is used as a perfluorinated polymer on the surface of the inner walls of the wells and the PTFE of the well extends to the top of the inner wall of the wells, the PTFE there can be used to provide a liquid tight and/or gas tight closure of the respective well.

Preferably, bottom seals are provided for sealing the wells below the associated filter. This way, liquid or gas inside the respective well is prevented from leaving the well via the filter before the filtration is desired.

In a possible embodiment, such a bottom seal has a top that is in contact with the associated filter, preferably such that no space is present between the top of the bottom seal and the associated filter. This embodiment is an example of how the well plate according to the invention can be designed such that just a very small quantity of substance is sufficient for successful crystallization and subsequent further investigations.

However, it is also possible to select the pore size of the filter in relation to the temperature profile and the viscosity of the mother liquor such that no mother liquor leaks through the pores of the filter. Also in that case, the well plate according to the invention is particularly suitable for performing crystallization and subsequent further investigation using just a very small quantity of substance.

In an advantageous embodiment, the septum or stopper is provided with at least one projection for a tighter closure. In addition, the wall with which the septum or stopper cooperates is provided with a corresponding groove. This groove is adapted to receive the projection or projections of the septum or stopper when the septum or stopper closes off the well. It is also possible that multiple grooves are present, each of them adapted to cooperate with one or more projections of the septum or stopper.

### BRIEF DESCRIPTION OF THE DRAWINGS

The invention will be explained in more detail under referral to the drawing, in which a non-limiting embodiment of the invention in shown. The drawing shows in:

FIG. 1: a preferred embodiment of the invention, partly shown in cross section,

FIG. 2: possible well shapes and stopper shapes,

FIG. 3: an enlarged cross section of a part of a well in a possible embodiment of the invention.

### DETAILED DESCRIPTION OF THE PREFERRED EMBODIMENTS

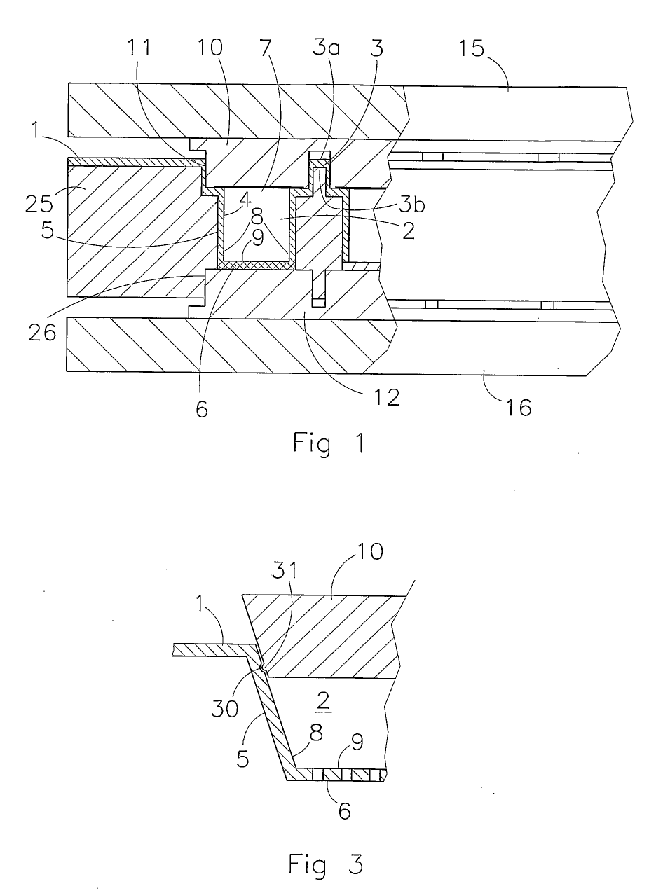

FIG. 1 shows a well plate 1 which is suitable for use in the method according to the invention. The well plate 1 is arranged in a well plate support 25. The well plate support 25 is made of a relatively strong and heat conductive material, such as metal, graphite or polymer ceramic.

The well plate 1 comprises a plurality of wells 2. Between the wells 2, intermediate plate sections 3 are present. Each intermediate plate section 3 has an upper face 3a and a lower face 3b. Each well 2 has an inner wall 4 and an outer wall 5. It is clear from FIG. 1 that the wells 2 protrude from the lower face 3b of the intermediate plate sections 3 and that the wall thickness of a well 2 is smaller than the depth of that well 2.

Each well has an open upper end 7.

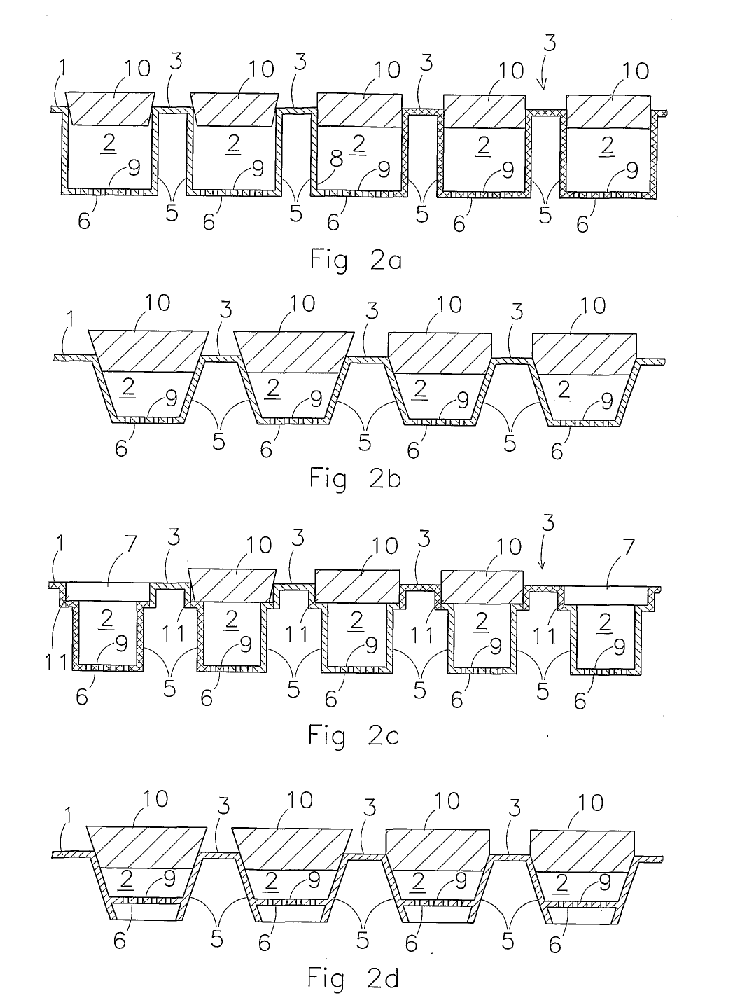

Each well 2 has an associated filter 6. The filters 6 and the wells 2 are integral parts of the well plate 1. In the example of FIG. 1, the filters 6 are arranged at the bottom of the associated well 2. It is however also possible that the filters 6 are not positioned at the very bottom of the well 2 but somewhere between the bottom of the well 2 and the upper end of the well 2 (see FIG. 2d). It is possible to fill the resulting cavity with another solvent, such as an antisolvent or the like.

Each of the filters 6 is provided with pores. In an advantageous embodiment the average pore diameter is about 1.2 micrometer. In most embodiments, the diameter of the pores in the filter will be between 0.05 micrometer and 10 micrometer. However, if large crystals are to be formed, the pores can be far larger, for example with a diameter of 1 millimeter.

Each of the wells 2 has an upper inner wall part above the filter 6. This upper inner wall part has a fluid contact surface 8. Each filter 6 has a top filter surface 9. According to the invention, at least both the fluid contact surface 8 of the well 2 and the top filter surface 9 are of an inert material as described herein elsewhere, such as and preferably, a perfluorinated polymer, such as polyvinylidene fluoride (PVDF) or perfluoroalkoxy (PFA). There is also envisaged an embodiment in which the fluid contact surface 8 of the well 2 and the top filter surface 9 are made from or coated with the inert material, preferably a perfluorinated polymer such as mentioned elsewhere.

In the embodiment of FIG. 1, the entire well plate 1 is made of an inert material that is at least substantially X-ray transparent, such as PTFE, PVDF or PFA. Alternatively, the well plate 1 can be made of another substantially X-ray transparent but less chemically resistant material and coated with any of these polymers to provide the required level of inertness to chemicals and solvents.

In the embodiment of FIG. 1, the open upper end 7 of the wells 2 is sealable by means of an upper septum or stopper 10. In this exemplary embodiment the upper septum or stopper 10 is made of PTFE. The septum or stopper can however be made of any suitable material. Also, it is possible that the septum or stopper is coated with for example PTFE or any other suitable material, in particular a perfluorinated polymer.

In the embodiment of FIG. 1, the wells 2 are provided with a wider portion 11 at their upper end. This wider portion 1 is adapted to receive the upper septum or stopper 10. However, also other forms of wells are possible, as is shown in FIG. 2. For example, straight, cylindrical wells with a substantially constant diameter along the height are possible or wells that have a tapered form.

As in the exemplary embodiment both the well plate 1 and the upper septa or stoppers 10 are made of PTFE, an additional sealing means such as an O-ring is in many cases not necessary any more.

In an alternative embodiment, which is not shown in the drawing, the upper septum or stopper 10 is not received by the upper end of the well itself, but by dedicated openings in the well plate support 25. Also, it is possible that the upper septum or stopper 10 is partly received by the well plate support 25 and partly by the respective well 2 itself.

In the wells, mother liquor or any other fluid substance can be present. In order to avoid that fluid substance in the well 2 leaks away during the experiment, the lower end of the wells 2 are sealable by means of a lower septum or stopper 12. In an alternative embodiment, the pore size of the filter is selected such that the viscosity of the fluids in the well prevents them from passing through the filter. Then, space may be present between the lower surface of the filter 6 and the upper surface of the lower septum or stopper 12.

In the embodiment of FIG. 1, the lower septum or stopper 12 is not received by the well 2 itself, but by opening 26 of the well plate support 25. It is however also possible that the well 2 comprises a lower section below the filter 6, which lower section is adapted to receive the lower septum or stopper 12. It is also possible that the lower septum or stopper 12 is partly received by the well plate support 25 and partly by the respective well 2 itself.

It is possible that each well 2 is provided with its own, separate upper septum or stopper 10 and lower septum or stopper 12. It is however also possible that adjacent septa or stoppers are connected to each other.

In an advantageous embodiment at least one lower septum or stopper 12 has a top that is in contact with the associated filter 6 such that no space is present between the top of the lower septum or stopper 12 and the associated filter 6. This way, when the substance to be crystallized is put into the well 2, no such substance is present below the filter 6, so no solids are formed below the filter 6. This is particularly advantageous in the cases where very small amounts of substances are used, such as in combinatorial chemistry. As the trend in research evolves towards the use of smaller and smaller amounts, this is particularly advantageous.

The metal well plate support 25 provides additional mechanical stability to the well plate 1 that in the embodiment of FIG. 1 is relatively thin. Also, as can be seen in FIG. 1, the well plate support 25 is in this embodiment in close contact with the outer walls of the wells 2. In crystallization experiments or in the further investigations, it is often necessary to supply heat to the substance in the wells 2 and/or to remove heat from substance in the wells 2. In the embodiment of FIG. 1, this can be achieved in an advantageous way via the well plate support 25. The metal of the well plate support 25 conducts the heat efficiently to the walls of the wells 2 or away from these walls.

Because the well plate 1 derives a mechanical stability from the well plate support 25, the wall thickness of the wells 2 can be kept small. This increases the thermal conductivity of the walls of the wells 2 significantly, because for example perfluorinated polymers (such as PTFE, PVDF, PFA) as such have a relatively low thermal conductivity.

So, the embodiment shown in FIG. 1 is especially advantageous with respect to the efficiency of the heat supply to the wells 2.

In the embodiment of FIG. 1, the well plate 1, the well plate support 25 and the septa or stoppers 10, 12 are arranged between base plate 16 and top plate 15 for additional closing force.

It is advantageous if the wells 2 of the well plate 1 can be sealed. If the wells in which crystals have formed are sealed, the well plate 1 can be stored for later investigation of the crystals.

The method according to the invention is particularly suitable for use in research with respect to crystals, for example in the context of the search for solid forms active pharmaceutical ingredients by means of combinatorial chemistry or high throughput screening.

In an advantageous embodiment of the method according to the present invention, first a well plate 1 as described above is provided. The wells 2 that will be used are sealed at the bottom by means of a lower septum or stopper 12 and/or bottom plate 16. After sealing the bottom of the wells 2, one or more substances and one or more solvents are provided, either separately or as solution or slurry in the respective wells 2 of the well plate 1. Initially, the substance or substances can be solids, but this is not necessary. In the embodiment shown, the lower septum or stopper 12 prevents the contents from leaking through the filter 6 because the top of the lower septum of stopper 12 is in contact with the filter 6.

The mixture of one or more substances and one or more solvents that is put in the well 2 will generally be in a solution or in a slurry form. The mixture contacts the wall of the respective well 2 at the fluid contact surface 8. It also contacts the top surface 9 of the filter 6. After putting the mixture into the wells 2, the open upper end 7 of the respective wells 2 is then closed by the upper septum or stopper 10 and/or top plate 15. Generally, different combinations of substances, solvents and concentrations are dispensed into the respective wells 2.

Then, the substances in the wells are subjected to a crystallizing process. In this process, the substance or substances are first dissolved and subsequently subjected to conditions that allow for the formation of solids, preferably crystals. The conditions are selected to increase the probability of the formation of crystalline material (rather than amorphous material) in the respective wells 2 of the well plate 1. The remaining liquid, containing non-solidified substance is indicated as mother liquor.

After a period of crystallization, the solvent can be removed by evaporation or the mother liquor can be removed by filtration or decantation. After this removal, further investigation of the crystals is performed while the crystals are still in the well of the well plate where they were formed.

The upper septum or stopper 10 may be removed before evaporation or before carrying out the further investigation.

Instead of removing the solvent by means of evaporation, the mother liquor with residual substance can also be removed by means of filtration. During the filtration, the crystals remain in the well in which they are formed. Filtration generally requires that at least the lower septum or stopper is removed.

The further investigation or investigations that are carried out on the crystals can involve any known investigation technique. For example, the crystals may be subjected to X-ray diffraction, spectroscopy (such as for example RAMAN, UV-Vis or IR), a visual investigation method and/or weighing of the total of formed crystals.

1. A method for obtaining and analyzing solids, preferably crystals, which method comprises the following steps:
providing a well plate,
the well plate comprising a plurality of wells, each of the wells having a depth and an open upper end and each of the wells being provided with a filter having pores, which filter is arranged at a distance below the open upper end,
each of the wells having an upper inner wall part above the filter that has a fluid contact surface and each filter having a top filter surface, at least both the fluid contact surface of the well and the top filter surface being of a material that is at least substantially inert for organic and/or aqueous solvents and/or mixtures of organic and aqueous solvents.
providing one or more substances and one or more solvents in at least one of the wells of the well plate,
applying conditions to dissolve the one or more substances in the one or more solvents;
applying conditions for crystallizing at least a part of the substance or substances so that solids are formed in the at least one well,
substantially removing the part of the substance that remains in solution, thereby leaving the solids, preferably crystals, that were formed from the substance in the well of the well plate in which they were formed, and
performing further investigation of the solids, preferably crystals, in the well of the well plate where they were formed.

2. The method according to claim 1, wherein the removal of the part of the substance that remains in solution is performed by means of filtration.

3. The method according to claim 1,
wherein the further investigation involves one or more techniques from the group of X-ray diffraction, infrared spectroscopy, RAMAN spectroscopy, UV-Vis, optical spectroscopy, weighing, visual inspection and/or spectroscopy microscopy.

4. The method according to claim 1, wherein the wells of the well plate are sealed at the bottom, prior to providing the one or more substance and one or more solvents to the wells.

5. The method according to claim 1, whereby the seals are removed after formation of the solids to allow removal of the part of the substance that remains in solution by filtration.

6. A well plate, suitable for use in crystallization as well as in investigation of crystals according to the method of claim 1,
the well plate comprising a plurality of wells,
each of the wells having a depth and an open upper end and each of the wells being provided with a filter having pores, which filter is arranged at a distance below the open upper end, and
each of the wells having an upper inner wall part above the filter that has a fluid contact surface and each filter having a top filter surface, at least both the fluid contact surface of the well and the top filter surface being of a material that is at least substantially inert for organic and/or aqueous solvents and/or mixtures of organic and aqueous solvents.

7. The well plate according to claim 6,
wherein the material of the well plate is X-ray transparent.

8. The well plate according to claim 6,
wherein the material of the well plate is a perfluorinated polymer.

9. The well plate according to claim 6,
wherein the inert material is one of the group of polyvinylidene fluoride, polytetrafluoroethylene, perfluoroalkoxy, fluorinated ethylene propylene, polytetrafluoroethylene-perfluoromethylvinylether, tetrafluoroethylene, hexafluoropropylene vinylidene fluoride, ethylene tetrafluoroethylene, ethylene chloro-trifluoroethylene, polyetheretherketone, polyetherimide.

10. The well plate according to claim 6,
wherein the well plate further comprises a plurality of intermediate plate sections between adjacent wells, and
each of the intermediate plate sections having an upper face and a lower face, the depth of the wells being such that the wells protrude from the lower face of the intermediate plate sections.

11. The well plate according to claim 6,
wherein the protruding part of a well has a wall thickness that is smaller than the depth of that well.

12. The well plate according to claim 6,
wherein the well plate comprises a well that is monolithic with the filter that is associated with said well.

13. The well plate according to claim 6,
wherein the well plate is at least partially provided with a coating of a perfluorinated polymer, for example polytetrafluoroethylene, polyvinylidene fluoride or perfluoroalkoxy.

14. The well plate according to claim 6,
wherein the well plate is monolithic.

15. The well plate according to claim 6,
wherein the well plate has a uniform wall thickness.

16. The well plate according to claim 6,
wherein at least one of the filters is arranged at a level below the lower face of the adjacent intermediate plate sections.

17. The well plate according to claim 6,
wherein the open upper end of at least one well is sealable.

18. The well plate according to claim 6,
wherein at least one well is sealable below the filter.

19. The well plate according to claim 6,
wherein the wells are arranged along a line.

20. The well plate according to claim 6,
wherein the wells are arranged in the form of a matrix.

21. The well plate according to claim 6,
wherein the pores of the filters have a diameter between 0.05 and 10 micrometer.

22. A combination of a well plate according to claim 6 and a well plate support,
which well plate support is suitable for receiving the well plate and which well plate support provides additional mechanical stability to the well plate.

23. The combination according to claim 22,
wherein the well plate support is made of metal.

24. The combination according to claim 22,
which combination further comprises one or more top seals for sealing the open upper end of each of the wells.

25. The combination according to claim 22,
which comprises one or more bottom seals for sealing the wells below the associated filter.

26. The combination according to claim 25,
wherein each of the bottom seals has a top that is in contact with the associated filter such that no space is present between the top of the bottom seal and the associated filter.

27. The combination according to claim 25,
wherein each of the bottom seals has a top that is in contact with the associated filter such that a space is present between the top of the bottom seal and the associated filter.
